(19) United States
(12) Patent Application Publication
(10) Pub. No.: US 2013/0212622 A1
(43) Pub. Date: Aug. 15, 2013

(54) INFORMATION INSERTION METHOD AND SYSTEM

(71) Applicants: Howard Chonghe YANG, San Jose, CA (US); Stephen Kuong-Io TAI, San Jose, CA (US)

(72) Inventors: Howard Chonghe YANG, San Jose, CA (US); Stephen Kuong-Io TAI, San Jose, CA (US)

(21) Appl. No.: 13/561,776

(22) Filed: Jul. 30, 2012

(30) Foreign Application Priority Data
Feb. 15, 2012 (CN) 201210034190.X

(51) Int. Cl. H04N 21/236

(52) U.S. Cl. 725/34

(57) ABSTRACT

An information insertion method and system are provided. The method includes: determining whether an insertion interval starts when a presentation module presents information from a first information source apparatus; when the interval starts, transmitting information from a second information source apparatus, preferably a local apparatus, into the presentation module for presentation; and when the interval ends, stopping transmission of information from the second apparatus into the presentation module, so that the module stops presenting information from the second apparatus and presents information from the first apparatus, thereby preventing the problem caused by channel switching or network congestion resulting in no image on the screen or temporary appearance of a screensaver image. Therefore, the information insertion can be conducted quickly at the beginning of the interval to provide an easy way for the operators to publish information very quickly or provide potential marketing opportunities for businesses to improve economic performance.

### BACKGROUND OF THE PRESENT INVENTION

1. Field of Invention

The present invention relates to the field of information presentation, and specifically to an information insertion method and system.

2. Description of Related Arts

With rapid development of digital television technologies, more and more people select to watch desired programs through the control of a set-top box. However, after receiving a channel switching operation of a user, it takes a certain processing time for an existing set-top box to change the program in a current channel to the program in another channel, resulting in that no television signal is transmitted into the television set during the short processing time, and thus the television screen displays disordered pictures or snowflakes appear, which affects user experience. To avoid the appearance of such disordered pictures, the set-top box is preset by the manufacturer so that after receiving a channel switching operation from a user, the set-top box outputs to the television set a signal that leads to a blank screen or makes the screen frozen at the picture before switching. The transitional blank screen or still picture usually lasts for 2 to 3 seconds, till the set-top box outputs a signal of the next channel. Obviously, if the blank screen switching mode is adopted, since the picture suddenly turns dark or bright, the strong contrast of light may cause discomfort of the user, especially when the user is watching television at night. Moreover, no matter whether the blank screen or the picture freezing mode is adopted for switching, the transitional channel switching time of 2 to 3 seconds is wasted because no information is provided for the user during this period of time, which is also a loss to the user.

Besides, not just for the television users, but those intending to watch television programs or film and television works online through mobile phones or computers, when they are enjoying audios and videos online, the playback of the information usually temporarily pauses due to network congestion or other reasons, and at this time, the picture generally shows a prompt of “buffering”. Apparently, the buffering time is also wasted for the user. Moreover, with the explosive growth of network information, when the user queries desired information with a search engine, it usually takes several seconds or even several minutes from initiating a query request to obtaining a query result, and likewise, the interval of several seconds or even several minutes is also wasted for the user. There are other similar cases, which will not be enumerated herein.

Therefore, how to make full use of these time intervals to provide a larger amount of and more effective information for the user is an issue to be urgently solved by those skilled in the art.

### SUMMARY OF THE PRESENT INVENTION

In view of the defects in the prior art, an object of the present invention is to provide an information insertion method and system, for solving the problem in the prior art that the picture being played back temporarily has no image due to channel switching or network congestion.

In order to accomplish the above and other objects, the present invention provides an information insertion method, which at least comprises:

1) determining whether an insertion interval starts when a presentation module presents information from a first information source apparatus; and

2) when it is determined that the insertion interval starts, transmitting information from a second information source apparatus into the presentation module for presentation, and when it is determined that the insertion interval ends, stopping transmitting the information from the second information source apparatus into the presentation module, so that the presentation module stops presenting the information from the second information source apparatus and presents the information from the first information source apparatus.

Preferably, the step 1) further comprises: when the presentation module presents the information from the first information source apparatus, acquiring a first operation of a user, and determining that the insertion interval starts.

Preferably, the step 1) further comprises: when the presentation module presents the information from the first information source apparatus, detecting that the presentation module fails to obtain in time the information from the first information source apparatus, and determining that the insertion interval starts.

Preferably, the first information source apparatus comprises an information providing apparatus disposed remote to a position where the presentation module resides; and the second information source apparatus comprises a storage apparatus disposed at the position where the presentation module resides.

The present invention provides an information insertion system, which at least comprises:

a determining module, for determining whether an insertion interval starts when a presentation module presents information from a first information source apparatus; and

an insertion module, for transmitting information from a second information source apparatus into the presentation module for presentation when the determining module determines that the insertion interval starts; and stopping transmitting the information from the second information source apparatus into the presentation module when the determining module determines that the insertion interval ends, so that the presentation module stops presenting the information from the second information source apparatus and presents the information from the first information source apparatus.

Preferably, the determining module further comprises: an acquiring unit, for acquiring a first operation of a user when the presentation module presents the information from the first information source apparatus, and determining that the insertion interval starts.

Preferably, the determining module further comprises: a detecting unit, for detecting that the presentation module fails to obtain in time the information from the first information source apparatus when the presentation module presents the information from the first information source apparatus, and determining that the insertion interval starts.

Preferably, the first information source apparatus comprises an information providing apparatus disposed remote to a position where the presentation module resides; and the second information source apparatus comprises a storage apparatus disposed at the position where the presentation module resides.

As described above, the information insertion method and system consistent with the present invention have the following beneficial effects: 1) when an insertion interval appears due to channel switching or network congestion, the awkward situation that the picture played back or displayed has no image may not occur; 2) information is presented to the user during the insertion interval, which not only meets the viewing demand of the user, but also provides potential business opportunities for more commercial activities; and 3) discomfort caused to the user by showing a blank screen during the insertion interval in the prior art is prevented.

### BRIEF DESCRIPTION OF THE DRAWINGS

FIG. 1 is a flow chart of an information insertion method consistent with the present invention.

FIG. 2a and FIG. 2b are detailed flow charts of the information insertion method consistent with the present invention.

FIG. 3 is a schematic view of an information insertion system consistent with the present invention.

### LIST OF REFERENCE NUMERALS

1 Information insertion system

11 Determining module

12 Insertion module

2 First information source apparatus

3 Presentation module

4 Second information source apparatus

### Detailed Description of the Preferred Embodiments

The embodiments of the present invention are described in the following through specific examples, and those skilled in the art can easily understand other advantages and effects of the present invention according to the content disclosed in the specification. The present invention may also be implemented or applied through other different specific examples, and various modifications and variations may be made to the details in the specification on the basis of different opinions and applications without departing from the principle of the present invention.

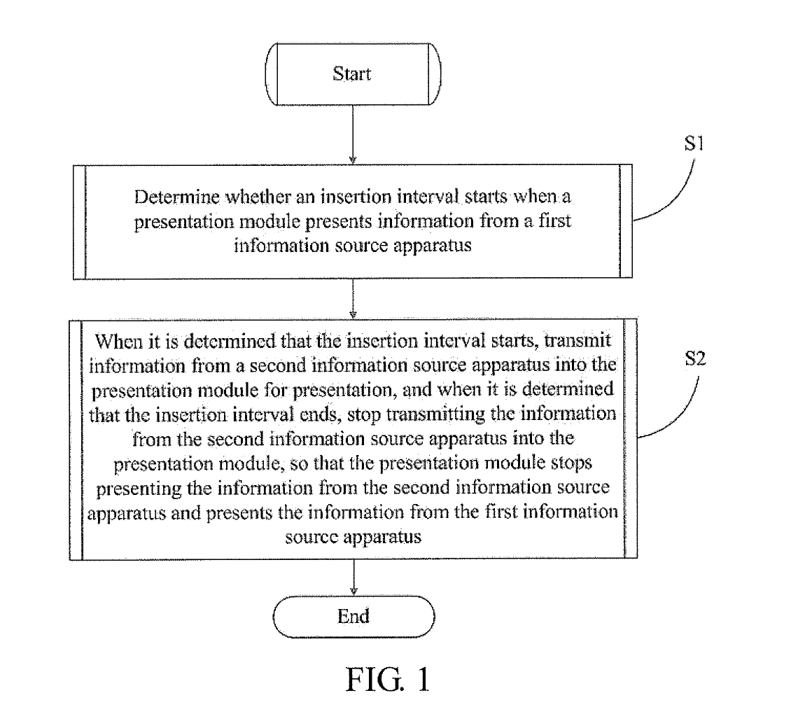

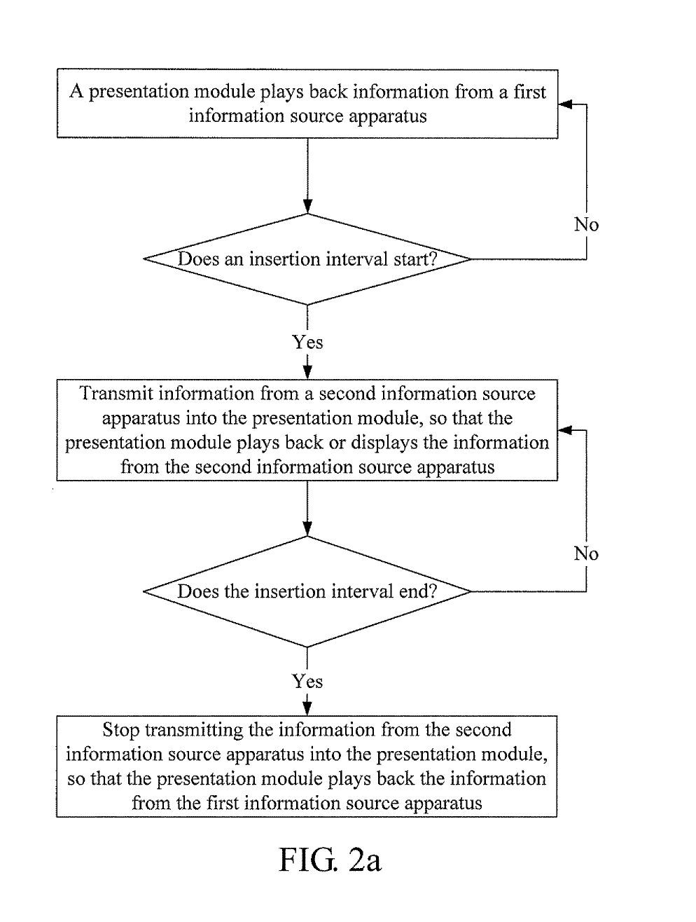

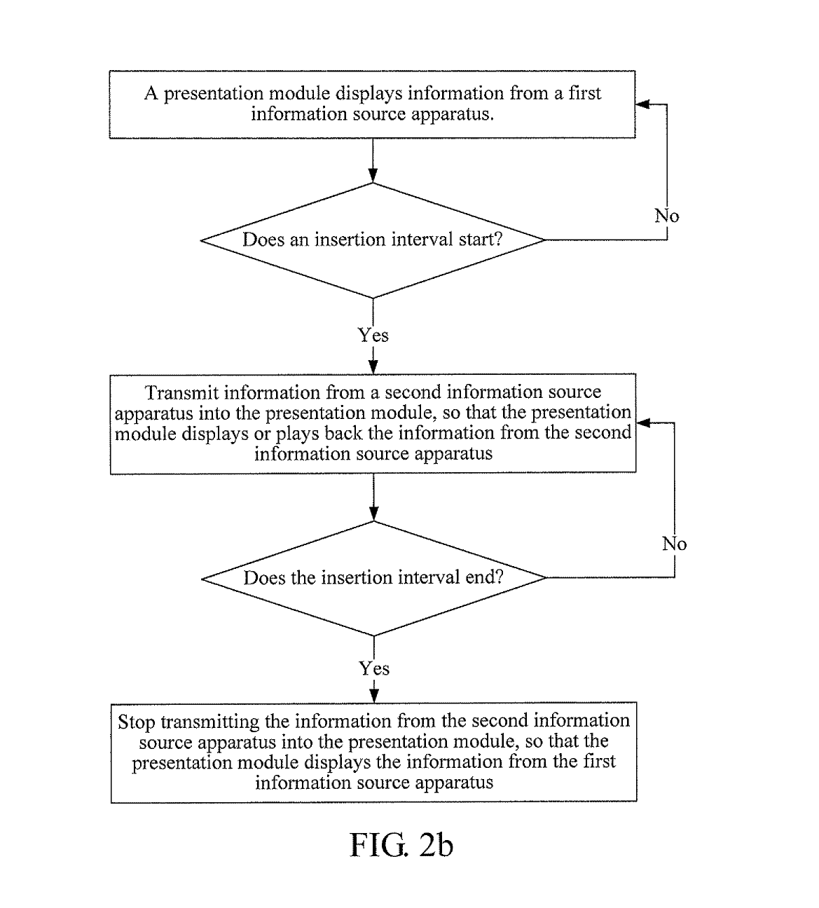

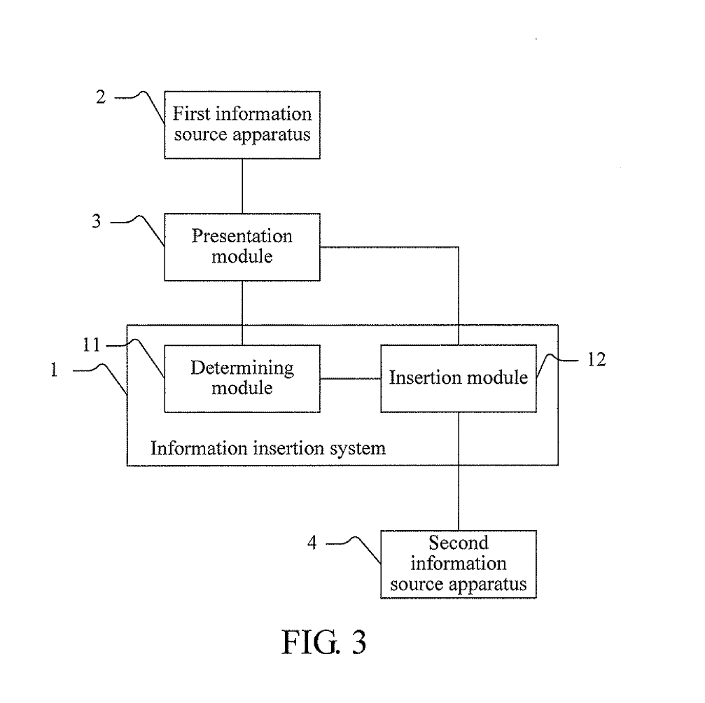

Referring to FIG. 1 and FIG. 2, it should be noted that, the drawings provided in this embodiment exemplary show the basic concept of the present invention, so that components related to the present invention are merely shown in the drawings and are not drawn based on the actual number, shape or size in implementation. The actual shape, number and proportion of each component in implementation may vary arbitrarily, and the layout of the components may also be more complex.

Referring to the figures, the present invention provides an information insertion method. The method provided in the present invention is mainly performed by an information insertion system, and the information insertion system is, for example, an application module mounted in a computer apparatus. The computer apparatus is a modern intelligent electronic apparatus capable of automatically computing a large amount of data and processing various information at a high speed according to a pre-stored program, and the hardware thereof includes, but is not limited to, a micro-processor, an FPGA, a DSP, and an embedded apparatus. The computer apparatus includes, but is not limited to, a set-top box, a smart phone, a PDA, or a personal computer.

In Step S1, when a presentation module presents information from a first information source apparatus, the information insertion system determines whether an insertion interval starts.

The insertion interval includes temporary pause of information presentation. Those skilled in the art should understand that, various factors that cause the insertion interval, for example, network congestion, operations of a user such as fast forward, reverse and channel switching, long-term search of a search engine and long-term presentation of identical information, may result in that the presentation module fails to obtain in time information to be presented subsequently, leading to the insertion interval.

It should be noted that, those skilled in the art should understand that the factors that cause the insertion interval are only exemplary, instead of limiting the present invention, and in fact, any factor that causes the temporary pause of the information presentation falls in the scope of the present invention.

The information insertion system determines whether an insertion interval starts in a manner based on the factors that cause the insertion interval, which includes, but is not limited to, the following aspects.

1) The information insertion system detects that the presentation module fails to obtain in time the information from the first information source apparatus, and determines that the insertion interval starts.

Specifically, as shown in FIG. 2a or FIG. 2b, when the presentation module plays back or displays the information from the first information source apparatus, the information insertion system monitors the presentation module, to determine whether the presentation module can obtain in time the information from the first information source apparatus. If the information insertion system detects that the presentation module can obtain in time the information from the first information source apparatus, the information insertion system determines that the insertion interval does not start yet, the presentation module continues to play back or display the information from the first information source apparatus, and the information insertion system continues to monitor the presentation module; and if the information insertion system detects that the presentation module cannot obtain in time the information from the first information source apparatus, the information insertion system determines that the insertion interval starts.

The circumstance that the presentation module fails to obtain in time the information from the first information source apparatus includes any case that causes the presentation module to stop presenting the information from the first information source apparatus, which preferably includes, but is not limited to, a case that the presentation module fails to receive subsequent information from the first information source apparatus within a preset time threshold; a case that the presentation module has processed all the information received from the first information source apparatus and does not receive any subsequent information from the first information source apparatus; and a case that the task being processed by the presentation module indicates that the presentation module cannot obtain in time subsequent information from the first information source apparatus.

For example, after a user inputs a key word for retrieval in a search interface from the first information source apparatus and presented by the presentation module, the presentation module processes the key word and transmits the key word to the first information source apparatus. Since the retrieval is time-consuming, when the presentation module is processing the key word for retrieval, the information insertion system determines that the presentation module cannot obtain in time subsequent retrieval result information from the first information source apparatus.

In another example, the information insertion system determines that the insertion interval starts if the information insertion system detects that the presentation module displays identical information in a preset time period, and also detects that the presentation module will present screensaver image information.

It should be noted that, those skilled in the art should understand that the circumstance that the presentation module fails to obtain in time the information from the first information source apparatus is only exemplary, instead of limiting the present invention, and in fact, any case that causes the presentation module to stop presenting the information from the first information source apparatus falls in the scope of the present invention.

2) When the presentation module presents the information from the first information source apparatus, the information insertion system acquires a first operation of a user, and determines that the insertion interval starts. This circumstance will be described in detail in Step S1′ subsequently.

It should be noted that, those skilled in the art should understand that the above description is only exemplary, instead of limiting the present invention, and in fact, any manner of determining whether an insertion interval starts falls in the scope of the present invention.

The presentation module is a presentation module associated with the computer apparatus where the information insertion system is mounted, and includes any module capable of processing and displaying graphics and characters and playing back information such as audios and videos. The presentation module preferably includes, but is not limited to, a television set disposed with a set-top box, and a playback processing module or a display processing module disposed in a smart phone, a PDA or a personal computer and capable of presenting audio and video information or network television program information from a network server. Specifically, when the computer apparatus where the information insertion system is mounted is a set-top box, the presentation module includes the set-top box and a television set connected to the set-top box; and when the computer apparatus where the information insertion system is mounted is a smart phone, a PDA or a personal computer, the presentation module is also mounted in the computer apparatus, and is a processing module for processing and then playing back or displaying received network information in the smart phone, the PDA or the personal computer. In an example, when the user enjoys television programs online through a network television player such as a PPTV player in a personal computer A1, the presentation module is a network television signal processing module containing the activated network television player in the personal computer A1. In another example, when the user enjoys a film C1 based on a web page B1 presented by a smart phone, the presentation module is a network audio and video information processing module containing a network audio and video player corresponding to the currently presented web page B1 in the smart phone. In still another example, when the user searches information based on a search web page B2 presented by a personal computer, the presentation module is a network search information processing module containing a web page browser for presenting the search web page B2 in the personal computer.

The first information source apparatus is an apparatus associated with the presentation module and capable of providing information to be presented, and preferably includes, but is not limited to, an information providing apparatus disposed remote to a position where the presentation module resides. In an example, when the presentation module includes a set-top box and a television set connected to the set-top box, the first information source apparatus is a broadcast signal apparatus for providing cable television signals, satellite television signals, and terrestrial television signals. In another example, when the presentation module is an activated network television signal processing module in a smart phone, a PDA or a personal computer, the first information source apparatus is a network television service apparatus for providing digital television program information. In still another example, when the presentation module is an activated network audio and video information processing module in a smart phone, a PDA or a personal computer, the first information source apparatus is a network server for providing audio and video information. In yet another example, when the presentation module is an activated network search information processing module in a set-top box, a smart phone, a PDA or a personal computer, the first information source apparatus is a network apparatus for providing query services.

It should be noted that, those skilled in the art should understand that, the above description is only exemplary, instead of limiting the present invention, and in fact, any presentation module associated with the computer apparatus where the information insertion system is mounted and any first information source apparatus associated with the presentation module fall in the scope of the present invention.

In Step S2, when determining that the insertion interval starts, the information insertion system transmits information from a second information source apparatus into the presentation module for presentation, and when determining that the insertion interval ends, the information insertion system stops transmitting the information from the second information source apparatus into the presentation module, so that the presentation module stops presenting the information from the second information source apparatus and continues to present the information from the first information source apparatus.

The information insertion system determines whether the insertion interval ends in a manner based on the factors that cause the insertion interval, which includes, but is not limited to, that the information insertion system detects that the presentation module receives subsequent information from the first information source apparatus, and determines that the insertion interval ends.

Specifically, as shown in FIG. 2a and FIG. 2b, the information insertion system determines that the insertion interval starts and transmits the information from the second information source apparatus into the presentation module, and the presentation module processes the information from the second information source apparatus and plays back or displays the processed information. Then, the information insertion system continues to monitor the presentation module, to determine whether the presentation module receives subsequent information from the first information source apparatus, if not, the information insertion system determines that the playback interval does not end, and continues to transmit the information from the second information source apparatus into the presentation module, so that the presentation module continues to play back or display the information from the second information source apparatus; and if yes, the information insertion system determines that the playback interval ends and stops transmitting the information from the second information source apparatus into the presentation module, and the presentation module processes the subsequent information received from the first information source apparatus and plays back or displays the processed subsequent information.

For example, when the information insertion system detects that a set-top box Y1 where the information insertion system is mounted, after processing satellite television signals provided by a broadcast signal apparatus X2 for providing television signals, does not receive any subsequent satellite television signal provided by the broadcast signal apparatus X2 for providing television signals, the information insertion system determines that the insertion interval starts, and transmits the information from the second information source apparatus into a processing unit of the set-top box Y1 for processing, so that the television set connected to the set-top box Y1 plays back the processed information. When the information insertion system detects that the presentation module Y1 receives subsequent satellite television signals from the broadcast signal apparatus X2 for providing television signals, the information insertion system determines that the insertion interval ends, and stops transmitting the information from the second information source apparatus into the processing unit of the set-top box Y1, so that the set-top box Y1 stops processing the information from the second information source apparatus and processes the received subsequent satellite television signals.

In another example, when the information insertion system detects that a network search information processing module Y12 in a personal computer where the information insertion system is mounted is processing a search word input by a user so as to provide the search word to a network apparatus X12 for providing query services, the information insertion system determines that the insertion interval starts, and processes the information from the second information source apparatus into a web page format to be displayed and transmits the processed information into the network search information processing module Y12, so that the network search information processing module Y12 processes and displays the information. When the information insertion system detects that the network search information processing module Y12 receives information from the network apparatus X12 for providing query services, the information insertion system determines that the insertion interval ends, and stops transmitting the information from the second information source apparatus into the network search information processing module Y12, so that the network search information processing module Y12 stops processing the information from the second information source apparatus and processes and displays the information from the network apparatus X12 for providing query services.

In another example, if the information insertion system detects that the presentation module will present screensaver image information, the information insertion system determines that the insertion interval starts and sends the information from the second information source apparatus into the presentation module for processing and presentation. If the information insertion system detects activating signals, such as keyboard operation or cursor movement, the information insertion system determines that the insertion interval ends and stops sending information from the second information source apparatus into the presentation module.

The second information source apparatus includes an apparatus capable of rapidly providing presentable information to the information insertion system, and preferably includes, but is not limited to, a storage apparatus disposed at the position where the presentation module resides, for example, a storage unit disposed in the computer apparatus where the information insertion system is mounted; or a storage apparatus such as a removable hard disk or a USB flash drive capable of being accessed by the information insertion system.

The information provided by the second information source apparatus includes any presentable information, which preferably includes, but is not limited to, advertisements, graphics, characters, video information, and audio information; and more preferably, the information provided by the second information source apparatus includes information attached with presentation rules, for example, information attached with presentation frequency and presentation time.

It should be noted that, those skilled in the art should understand that the information from the second information source apparatus and the information from the first information source apparatus may be of the same type or different types. In an example, when the information from the first information source apparatus that is presented by the presentation module is audio and video information, the information from the second information source apparatus that is transmitted by the information insertion system into the presentation module may be audio and video information, or information such as graphics and characters that do not contain audio information. In another example, when the information from the first information source apparatus that is presented by the presentation module is information such as graphics and characters that do not contain audio information, the information from the second information source apparatus that is transmitted by the information insertion system into the presentation module may be audio and video information.

As a preferred implementation, the information provided by the second information source apparatus is pre-stored in the second information source apparatus or pre-recorded in the second information source apparatus.

As another preferred implementation, the information provided by the second information source apparatus is stored or updated by the information insertion system. Specifically, the information insertion system extracts non-real-time presented information in the information from the first information source apparatus, and stores the extracted information into the second information source apparatus or uses the extracted information to update information stored in the second information source apparatus. The non-real-time presented information includes any information that does not require to be presented in real time, which preferably includes, but is not limited to, advertisements, graphics, and characters; and more preferably includes information attached with presentation rules, for example, information attached with presentation frequency and presentation time.

For example, the information insertion system extracts, based on a preset protocol, non-real-time presented information from an 8th frame of information in a television series AS provided by an apparatus X11 and received by the presentation module, and updates information stored in the storage unit of the computer apparatus where the information insertion system is mounted. When detecting that the presentation module fails to obtain in time a frame after the 8th frame, for example, a 35th frame, in the television series A5, the information insertion system acquires the stored non-real-time presented information from the storage unit of the computer apparatus where the information insertion system is mounted, and transmits the acquired information into the presentation module for playback.

As a preferred implementation, according to the method consistent with the present invention, Step S1 further includes Step S1′ (not shown).

In Step S1′, when the presentation module presents the information from the first information source apparatus, the information insertion system acquires a first operation of a user and determines that the insertion interval starts, and then the information insertion system performs Step S2.

The first operation includes any operation that may cause the insertion interval, which preferably includes, but is not limited to, a channel switching operation, a fast forward operation or a reverse operation.

For example, when a television set Y2 connected to the set-top box where the information insertion system is mounted plays back a television program C4 in a channel 15, the information insertion system receives a channel switching operation of switching to a channel 30 sent by a user through a man-machine interactive apparatus such as a remote control, and determines that the insertion interval starts. The set-top box where the information insertion system is mounted sends, based on the channel switching operation, an information changing request for providing program information of the channel 30 to a broadcast signal apparatus X22, and meanwhile, the information insertion system transmits information C5 from a storage unit of the set-top box where the information insertion system is mounted into a processing unit of the set-top box for processing, so that the television set Y2 plays back the information C5 in the channel 30. When the information insertion system detects that the set-top box where the information insertion system is mounted has received program information C30 of the channel 30 from the broadcast signal apparatus X22, the information insertion system stops transmitting the information from the storage unit of the set-top box into the processing unit of the set-top box, so that the television set Y2 stops playing back the information from the storage unit and plays back the program information C30 of the channel 30.

As a preferred implementation, the method consistent with the present invention further includes a step of changing, based on a second operation of the user, the information being presented into the information from the other information source apparatus.

The second operation includes an operation of changing the currently presented information into the information from the other information source apparatus. Specifically, when the currently presented information is from the first information source apparatus, the second operation is an operation of changing the currently presented information into the information from the second information source apparatus; and when the currently presented information is from the second information source apparatus, the second operation is an operation of changing the currently presented information into the information from the first information source apparatus.

For example, when a user views a film C6 online through a mobile phone where the information insertion system is mounted, the information insertion system detects that after a network audio and video information processing module Y4 for processing the film C6 in the mobile phone processes a 100th frame of the film C6 from a network server X13, the network audio and video information processing module Y4 fails to obtain a 101st frame of information of the film C6 in time due to reasons such as network congestion. In this case, the information insertion system determines that the insertion interval starts, and transmits information C7 stored in a storage card of the mobile phone into the network audio and video information processing module Y4. When detecting that the network audio and video player Y4 receives the 101st frame of information of the film C6, the information insertion system determines that the insertion interval ends, and stops transmitting the information stored in the storage card of the mobile phone into the network audio and video information processing module Y4, so that the network audio and video information processing module Y4 continues to process and play back the film C6. However, when the user performs a second operation out of interest to the information C7 or other reasons through a man-machine interactive apparatus such as a keypad or a touch screen of the mobile phone, the information insertion system intercepts, based on the second operation of the user, the film C6 transmitted into the network audio and video information processing module Y4, and acquires the information from the storage card in the mobile phone and transmits the acquired information into the network audio and video information processing module Y4, so that the network audio and video information processing module Y4 stops processing the film C6 and processes and plays back the information from the storage card in the mobile phone. Similarly, when the network audio and video information processing module Y4 plays back the information from the storage card in the mobile phone, the information insertion system stops, based on another second operation of the user, intercepting the film C6 transmitted into the network audio and video information processing module Y4, and stops transmitting the information from the storage card in the mobile phone into the network audio and video information processing module Y4, so that the network audio and video information processing module Y4 changes the information being played backed which is from the storage card in the mobile phone into the film C6 from the network server X13. Moreover, when the network audio and video information processing module Y4 plays back the information from the storage card in the mobile phone, the user may control the network audio and video information processing module Y4 through the man-machine interactive apparatus, so that the network audio and video information processing module Y4 reviews the information from the storage card in the mobile phone that has already been played back.

Further, it should be noted that, those skilled in the art should understand that before transmitting the information from the second information source apparatus into the presentation module, the information insertion system needs to determine, based on the type of the presentation module and the format of the information from the second information source apparatus, whether to implement processing such as format conversion on the information from the second information source apparatus. For example, when the presentation module is a network audio and video information processing module, if the format of the information from the second information source apparatus cannot be recognized by the network audio and video information processing module, the information insertion system converts the format of the information from the second information source apparatus and then transmits the information into the network audio and video information processing module.

Referring to FIG. 2, an information insertion system 1 consistent with the present invention includes a determining module 11 and an insertion module 12.

When a presentation module 3 presents information from a first information source apparatus 2, the determining module 11 determines whether an insertion interval starts.

The insertion interval includes temporary pause of information presentation. Those skilled in the art should understand that, various factors that cause the insertion interval, for example, network congestion, operations of a user such as fast forward, reverse and channel switching, long-term search of a search engine and long-term presentation of identical information, may result in that the presentation module 3 fails to obtain in time information to be presented subsequently, leading to the insertion interval.

It should be noted that, those skilled in the art should understand that the factors that cause the insertion interval are only exemplary, instead of limiting the present invention, and in fact, any factor that causes the temporary pause of the information presentation falls in the scope of the present invention.

The determining module 11 determines whether an insertion interval starts in a manner based on the factors that cause the insertion interval, which includes, but is not limited to, the following aspects.

1) The determining module 11 includes a detecting unit (not shown). The detecting unit detects that the presentation module 3 fails to obtain in time the information from the first information source apparatus 2, and determines that the insertion interval starts.

Specifically, when the presentation module plays back or displays the information from the first information source apparatus, the detecting unit monitors the presentation module 3, to determine whether the presentation module can obtain in time the information from the first information source apparatus. If the detecting unit detects that the presentation module can obtain in time the information from the first information source apparatus, the detecting unit determines that the insertion interval does not start yet, the presentation module continues to play back or display the information from the first information source apparatus, and the detecting unit continues to monitor the presentation module; and if the detecting unit detects that the presentation module cannot obtain in time the information from the first information source apparatus, the detecting unit determines that the insertion interval starts.

The circumstance that the presentation module fails to obtain in time the information from the first information source apparatus includes any case that causes the presentation module to stop presenting the information from the first information source apparatus, which preferably includes, but is not limited to, a case that the presentation module fails to receive subsequent information from the first information source apparatus within a preset time threshold; a case that the presentation module has processed all the information received from the first information source apparatus and does not receive any subsequent information from the first information source apparatus; and a case that the task being processed by the presentation module 3 indicates that the presentation module cannot obtain in time subsequent information from the first information source apparatus.

For example, after a user inputs a key word for retrieval in a search interface from the first information source apparatus and presented by the presentation module 3, the presentation module 3 processes the key word and transmits the key word to the first information source apparatus 2. Since the retrieval is time-consuming, when the presentation module 3 is processing the key word for retrieval, the detecting unit determines that the presentation module 3 cannot obtain in time subsequent retrieval result information from the first information source apparatus 2.

In another example, the information insertion system determines that the insertion interval starts if the information insertion system detects that the presentation module displays identical information in a preset time period, and detects that the presentation module will present screensaver image information.

It should be noted that, those skilled in the art should understand that the circumstance that the presentation module fails to obtain in time the information from the first information source apparatus is only exemplary, instead of limiting the present invention, and in fact, any case that causes the presentation module to stop presenting the information from the first information source apparatus falls in the scope of the present invention.

2) When the presentation module 3 presents the information from the first information source apparatus 2, the determining module 11 acquires a first operation of a user, and determines that the insertion interval starts. This circumstance will be described in detail below with reference to an acquiring unit.

It should be noted that, those skilled in the art should understand that the above description is only exemplary, instead of limiting the present invention, and in fact, any manner of determining whether an insertion interval starts falls in the scope of the present invention.

The presentation module 3 is a presentation module associated with the computer apparatus where the information insertion system 1 is mounted, and includes any unit capable of displaying graphics and characters and playing back information such as audios and videos. The presentation module 3 preferably includes, but is not limited to, a television set disposed with a set-top box, and a playback processing module or a display processing module/unit disposed in a smart phone, a PDA or a personal computer and capable of processing and then presenting audio and video information or network television program information from a network server. Specifically, when the computer apparatus where the information insertion system 1 is mounted is a set-top box, the presentation module 3 includes the set-top box and a television set connected to the set-top box; and when the computer apparatus where the information insertion system 1 is mounted is a smart phone, a PDA or a personal computer, the presentation module 3 is also mounted in the computer apparatus, and is a processing module for processing and then playing back or displaying received network information in the smart phone, the PDA or the personal computer. In an example, when the user enjoys television programs online through a network television player such as a PPTV player in a personal computer A1, the presentation module 3 is a network television signal processing module containing the activated network television player in the personal computer A1. In another example, when the user enjoys a film C1 based on a web page B1 presented by a smart phone, the presentation module 3 is a network audio and video information processing module containing a network audio and video player corresponding to the currently presented web page B1 in the smart phone. In still another example, when the user searches information based on a search web page B2 presented by a personal computer, the presentation module 3 is a network search information processing module containing a web page browser for presenting the search web page B2 in the personal computer.

The first information source apparatus 2 is an apparatus associated with the presentation module 3 and capable of providing information to be presented, and preferably includes, but is not limited to, an information providing apparatus disposed remote to a position where the presentation module 3 resides. In an example, when the presentation module 3 includes a set-top box and a television set connected to the set-top box, the first information source apparatus 2 is a broadcast signal apparatus for providing cable television signals, satellite television signals, and terrestrial television signals. In another example, when the presentation module 3 is an activated network television signal processing module in a smart phone, a PDA or a personal computer, the first information source apparatus 2 is a network television service apparatus for providing digital television program information. In still another example, when the presentation module 3 is an activated network audio and video information processing module in a smart phone, a PDA or a personal computer, the first information source apparatus 2 is a network server for providing audio and video information. In yet another example, when the presentation module 3 is an activated network search information processing module in a set-top box, a smart phone, a PDA or a personal computer, the first information source apparatus 2 is a network apparatus for providing query services.

It should be noted that, those skilled in the art should understand that, the above description is only exemplary, instead of limiting the present invention, and in fact, any presentation module associated with the computer apparatus where the information insertion system is mounted and any first information source apparatus associated with the presentation module fall in the scope of the present invention.

When the determining module 11 determines that the insertion interval starts, the insertion module 12 transmits information from a second information source apparatus 4 into the presentation module 3 for presentation, and when the determining module 11 determines that the insertion interval ends, the insertion module 12 stops transmitting the information from the second information source apparatus 4 into the presentation module 3, so that the presentation module 3 stops presenting the information from the second information source apparatus 4 and presents the information from the first information source apparatus 2.

The determining module 11 determines whether the insertion interval ends in a manner based on the factors that cause the insertion interval, which includes, but is not limited to, that the determining module 11 detects that the presentation module 3 receives subsequent information from the first information source apparatus 2, and determines that the insertion interval ends.

For example, when the determining module 11 detects that a set-top box Y1 where the determining module 11 is mounted, after processing satellite television signals provided by a broadcast signal apparatus X2 for providing television signals, does not receive any subsequent satellite television signal provided by the broadcast signal apparatus X2 for providing television signals, the determining module 11 determines that the insertion interval starts, and the insertion module 12 transmits the information from the second information source apparatus 4 into a processing unit of the set-top box Y1 for processing, so that the television set connected to the set-top box Y1 plays back the processed information. When the determining module 11 detects that the set-top box Y1 receives subsequent satellite television signals from the broadcast signal apparatus X2 for providing television signals, the determining module 11 determines that the insertion interval ends, and the insertion module 12 stops transmitting the information from the second information source apparatus 4 into the processing unit of the set-top box Y1, so that the set-top box Y1 stops processing the information from the second information source apparatus 4 and processes the received subsequent satellite television signals.

In another example, when the determining module 11 detects that a network search information processing module Y12 in a personal computer where the determining module 11 is mounted is processing a search word input by a user so as to provide the search word to a network apparatus X12 for providing query services, the determining module 11 determines that the insertion interval starts, and the insertion module 12 processes the information from the second information source apparatus into a web page format to be displayed and transmits the processed information into the network search information processing module Y12, so that the network search information processing module Y12 displays the information. When the determining module 11 detects that the network search information processing module Y12 receives information from the network apparatus X12 for providing query services, the determining module 11 determines that the insertion interval ends, and the insertion module 12 stops transmitting the information from the second information source apparatus into the network search information processing module Y12, so that the network search information processing module Y12 stops processing the information from the second information source apparatus and processes and displays the information from the network apparatus X12 for providing query services.

In another example, if the determining module 11 detects that the presentation module will present screensaver image information, the information insertion system determines that the insertion interval starts and the insertion module 12 sends the information from the second information source apparatus into the presentation module for processing and presentation. If the determining module 11 detects activating signals, such as keyboard operation or cursor movement, the information insertion system determines that the insertion interval ends and the insertion module 12 stops sending information from the second information source apparatus into the presentation module.

The second information source apparatus 4 includes an apparatus capable of rapidly providing presentable information to the insertion module 12, and preferably includes, but is not limited to, a storage apparatus disposed at the position where the presentation module 3 resides, for example, a storage unit disposed in the computer apparatus where the information insertion system 1 is mounted; or a storage apparatus such as a removable hard disk or a USB flash drive capable of being accessed by the insertion module 12.

The information provided by the second information source apparatus 4 includes any presentable information, which preferably includes, but is not limited to, advertisements, graphics, characters, video information, and audio information; and more preferably, the information provided by the second information source apparatus 4 includes information attached with presentation rules, for example, information attached with presentation frequency and presentation time.

It should be noted that, those skilled in the art should understand that the information from the second information source apparatus 4 and the information from the first information source apparatus 2 may be of the same type or different types. In an example, when the information from the first information source apparatus 2 that is presented by the presentation module 3 is audio and video information, the information from the second information source apparatus 4 that is transmitted by the insertion module 12 into the presentation module 3 may be audio and video information, or information such as graphics and characters that do not contain audio information. In another example, when the information from the first information source apparatus 2 that is presented by the presentation module 3 is information such as graphics and characters that do not contain audio information, the information from the second information source apparatus 4 that is transmitted by the insertion module 12 into the presentation module 3 may be audio and video information.

As a preferred implementation, the information provided by the second information source apparatus 4 is pre-stored in the second information source apparatus 4 or pre-recorded in the second information source apparatus 4.

As another preferred implementation, the information insertion system 1 further includes an updating module (not shown), and the information provided by the second information source apparatus 4 is stored by the updating module. Specifically, the updating module extracts non-real-time presented information in the information from the first information source apparatus, and stores the extracted information into the second information source apparatus 4 or uses the extracted information to update information stored in the second information source apparatus 4. The non-real-time presented information includes any information that does not require to be presented in real time, which preferably includes, but is not limited to, advertisements, graphics, and characters; and more preferably includes information attached with presentation rules, for example, information attached with presentation frequency and presentation time.

For example, the updating module extracts, based on a preset protocol, non-real-time presented information from an 8th frame of information in a television series A5 provided by an apparatus X11 and received by the presentation module 3, and updates information stored in the storage unit of the computer apparatus where the updating module is mounted. When the determining module 11 detects that the presentation module 3 fails to obtain in time a frame after the 8th frame, for example, a 35th frame, in the television series A5, the insertion module 12 acquires the non-real-time presented information stored by the updating module from the storage unit of the computer apparatus where the insertion module 12 is mounted, and transmits the acquired information into the presentation module 3 for playback.

As a preferred implementation, the insertion module 12 consistent with the present invention further includes an acquiring unit (not shown).

When the presentation module 3 presents the information from the first information source apparatus 2, the acquiring unit acquires a first operation of a user and determines that the insertion interval starts, and then the insertion module 12 performs the operation.

The first operation includes any operation that may cause the insertion interval, which preferably includes, but is not limited to, a channel switching operation, a fast forward operation or a reverse operation.

For example, when a television set Y2 connected to the set-top box where the information insertion system 1 is mounted plays back a television program C4 in a channel 15, the acquiring unit receives a channel switching operation of switching to a channel 30 sent by a user through a man-machine interactive apparatus such as a remote control, and determines that the insertion interval starts. The set-top box where the information insertion system 1 is mounted sends, based on the channel switching operation, an information changing request for providing program information of the channel 30 to a broadcast signal apparatus X22, and meanwhile, the insertion module 12 transmits information C5 from a storage unit of the set-top box where the insertion module 12 is mounted into a processing unit of the set-top box for processing, so that the television set Y2 plays back the information C5 in the channel 30. When the determining module 11 detects that the set-top box where the determining module 11 is mounted has received program information C30 of the channel 30 from the broadcast signal apparatus X2, the insertion module 12 stops transmitting the information from the storage unit of the set-top box into the processing unit of the set-top box, so that the television set Y2 stops playing back the information from the storage unit and plays back the program information C30 of the channel 30.

As a preferred implementation, the information insertion system 1 further includes a changing module (not shown). The changing module changes, based on a second operation of the user, the information being presented into the information from the other information source apparatus.

The second operation includes an operation of changing the currently presented information into the information from the other information source apparatus. Specifically, when the currently presented information is from the first information source apparatus, the second operation is an operation of changing the currently presented information into the information from the second information source apparatus; and when the currently presented information is from the second information source apparatus, the second operation is an operation of changing the currently presented information into the information from the first information source apparatus.

For example, when a user views a film C6 online through a mobile phone where the information insertion system 1 is mounted, the determining module 11 detects that after a network audio and video information processing module Y4 for processing the film C6 in the mobile phone processes a 100th frame of the film C6 from a network server X13, the network audio and video information processing module Y4 fails to obtain a 101st frame of information of the film C6 in time due to reasons such as network congestion. In this case, the determining module 11 determines that the insertion interval starts, and the insertion module 12 transmits information C7 stored in a storage card of the mobile phone into the network audio and video information processing module Y4. When detecting that the network audio and video information processing module Y4 receives the 101st frame of information of the film C6, the determining module 11 determines that the insertion interval ends, and the insertion module 12 stops transmitting the information stored in the storage card of the mobile phone into the network audio and video information processing module Y4, so that the network audio and video information processing module Y4 continues to process and play back the film C6. However, when the user performs a second operation out of interest to the information C7 or other reasons through a man-machine interactive apparatus such as a keypad or a touch screen of the mobile phone, the changing module intercepts, based on the second operation of the user, the film C6 transmitted into the network audio and video information processing module Y4, and the insertion module 12 again acquires the information from the storage card in the mobile phone and transmits the acquired information into the network audio and video information processing module Y4, so that the network audio and video information processing module Y4 stops processing the film C6 and processes and plays back the information from the storage card in the mobile phone. Similarly, when the network audio and video information processing module Y4 plays back the information from the storage card in the mobile phone, the changing module stops, based on another second operation of the user, intercepting the film C6 transmitted into the network audio and video information processing module Y4, and the insertion module 12 stops transmitting the information from the storage card in the mobile phone into the network audio and video information processing module Y4, so that the network audio and video information processing module Y4 changes the information being played backed which is from the storage card in the mobile phone into the film C6 from the network server X13.

Moreover, when the network audio and video information processing module Y4 plays back the information from the storage card in the mobile phone, the user may control the network audio and video information processing module Y4 through the man-machine interactive apparatus, so that the network audio and video information processing module Y4 reviews the information from the storage card in the mobile phone that has already been played back.

Further, it should be noted that, those skilled in the art should understand that before transmitting the information from the second information source apparatus into the presentation module, the insertion module needs to determine, based on the type of the presentation module and the format of the information from the second information source apparatus, whether to implement processing such as format conversion on the information from the second information source apparatus. For example, when the presentation module is a network audio and video information processing module, if the format of the information from the first information source apparatus cannot be recognized by the network audio and video information processing module, the insertion module converts the format of the information from the second information source apparatus and then transmits the information into the network audio and video information processing module.

In summary, according to the information insertion method and system consistent with the present invention, to solve the problem of an insertion interval caused by channel switching, network congestion or long-term image stagnation when a user is enjoying television programs or audio and video information or is querying information, information is acquired from a local second information source apparatus and insertion during the insertion interval, so as to avoid the scenario that no image is presented on the screen or appearance of screensaver image. Moreover, the inserted information could be locally downloaded without requiring frequent downloading from the remote site which will take up useful channel resources. Although the inserted information could be provided or updated by remote device, it is possible to download such inserted information via free network channel without affecting regular information transferring. Furthermore, compared with the existing information presentation manner, the method consistent with the present invention can provide more information to the user within the same time, which not only meets the viewing demand of the user, but also provides potential business opportunities for more commercial activities. Besides, by inserting the information from the second information source apparatus during the insertion interval, discomfort caused by showing a blank screen to the user in the prior art is prevented. In addition, the information from the second information source apparatus may be updated based on information provided by a first information source apparatus. Therefore, the present invention effectively eliminates the defects in the prior art and has high industrial applicability.

The above description of the detailed embodiments is only to illustrate the preferred implementation according to the present invention, and it is not to limit the scope of the present invention. Accordingly, all modifications and variations completed by those with ordinary skill in the art should fall within the scope of the present invention defined by the appended claims.

What is claimed is:

1. An information insertion method, at least comprising:
A. determining whether an insertion interval starts when a presentation module presents information from a first information source apparatus; and
B. when it is determined that the insertion interval starts, transmitting information from a second information source apparatus into the presentation module for presentation, and when it is determined that the insertion interval ends, stopping transmitting the information from the second information source apparatus into the presentation module, so that the presentation module stops presenting the information from the second information source apparatus and presents the information from the first information source apparatus.

2. The information insertion method as in claim 1, wherein the step A further comprises:
when the presentation module presents the information from the first information source apparatus, acquiring a first operation of a user, and determining that the insertion interval starts.

3. The information insertion method as in claim 2, wherein the first operation comprises one of the following:
a channel switching operation;
a fast forward operation; and
a reverse operation.

4. The information insertion method as in claim 1, wherein the step A further comprises:
when the presentation module presents the information from the first information source apparatus, detecting that the presentation module fails to obtain in time the information from the first information source apparatus, and determining that the insertion interval starts.

5. The information insertion method as in claim 1, further comprising:
extracting non-real-time presented information in the information from the first information source apparatus, and storing the extracted information into the second information source apparatus or using the extracted information to update information stored in the second information source apparatus.

6. The information insertion method as in claim 1, wherein the second information source apparatus comprises a storage apparatus disposed at a position where the presentation module resides.

7. The information insertion method as in claim 5, wherein the second information source apparatus comprises a storage apparatus disposed at a position where the presentation module resides.

8. The information insertion method as in claim 1, further comprising:
based on a second operation of a user, changing the information being presented into the information from the other information source apparatus.

9. The information insertion method as in claim 1, wherein the first information source apparatus comprises an information providing apparatus disposed remote to a position where the presentation module resides.

10. The information insertion method as in claim 9, wherein the information providing apparatus comprises one of a broadcast signal apparatus for providing television signals, a network apparatus for providing audio and video information, a network television service apparatus for providing digital television program information, and a network apparatus for providing query services.

11. An information insertion system, at least comprising:
a determining module, for determining whether an insertion interval starts when a presentation module presents information from a first information source apparatus; and
an insertion module, for transmitting information from a second information source apparatus into the presentation module for presentation when the determining module determines that the insertion interval starts; and stopping transmitting the information from the second information source apparatus into the presentation module when the determining module determines that the insertion interval ends, so that the presentation module stops presenting the information from the second information source apparatus and presents the information from the first information source apparatus.

12. The information insertion system as in claim 11, wherein the determining module further comprises:
an acquiring unit, for acquiring a first operation of a user when the presentation module presents the information from the first information source apparatus, and determining that the insertion interval starts.

13. The information insertion system as in claim 12, wherein the first operation comprises one of the following:
a channel switching operation;
a fast forward operation; and
a reverse operation.

14. The information insertion system as in claim 11, wherein the determining module further comprises:
a detecting unit, for detecting that the presentation module fails to obtain in time the information from the first information source apparatus when the presentation module presents the information from the first information source apparatus, and determining that the insertion interval starts.

15. The information insertion system as in claim 11, further comprising:
an updating module, for extracting non-real-time presented information in the information from the first information source apparatus, and storing the extracted information into the second information source apparatus or using the extracted information to update information stored in the second information source apparatus.

16. The information insertion system as in claim 11, wherein the second information source apparatus comprises a storage apparatus disposed at a position where the presentation module resides.

17. The information insertion system as in claim 15, wherein the second information source apparatus comprises a storage apparatus disposed at a position where the presentation module resides.

18. The information insertion system as in claim 11, further comprising:
a changing module, for changing, based on a second operation of a user, the information being presented into the information from the other information source apparatus.

19. The information insertion system as in claim 11, wherein the first information source apparatus comprises an information providing apparatus disposed remote to a position where the presentation module resides.

20. The information insertion system as in claim 19, wherein the information providing apparatus comprises one of a broadcast signal apparatus for providing television signals, a network apparatus for providing audio and video information, a network television service apparatus for providing digital television program information, and a network apparatus for providing query services.
